(19) United States
(12) Patent Application Publication
(10) Pub. No.: US 2002/0049930 A1
(43) Pub. Date: Apr. 25, 2002

(54) Protocol analysis framework

(75) Inventor: Barry Hannigan, Williamstown, NJ (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(73) Assignee: INRANGE Technologies Corporation, Lumberton, NJ (US)

(21) Appl. No.: 09/919,353

(22) Filed: Jul. 31, 2001

Related U.S. Application Data
(60) Provisional application No. 60/230,839, filed on Sep. 7, 2000.

(51) Int. Cl. G06F 11/24

(52) U.S. Cl. 714/39

(57) ABSTRACT

A framework of dynamic link libraries (DLLs) enables an application to perform protocol analysis of messages from multiple protocols. The framework is modular, allowing new protocol-specific modules to be added when analysis of new protocols is required. Analysis of multiple protocols is optionally executed simultaneously.

### RELATED APPLICATION(S)

This application claims the benefit of U.S. Provisional Patent Application No. 60/230,839 filed Sep. 7, 2000; the entire teachings of which are incorporated herein by reference.

### BACKGROUND OF THE INVENTION

Devices use common protocols to communicate with other devices. Protocol analysis is used to decode messages to text, filter messages based on selected criteria, and filter messages based on belonging to a particular session. An example of such protocol analysis is session filtering. A session includes a group of messages that are used to establish a phone call, for instance, and continue through the release of that phone call. For example, in the SS7 protocol, a phone call starts with an Initial Address Message (IAM) and ends with a Release Complete (RLC) message. A session filter performing protocol analysis can be used to identify messages that are part of a particular phone call.

Numerous protocols exist, each adapted to various requirements. For example, the telephone signaling networks use protocols, such as: SS7 ANSI, SS7 ITUT, ISDN protocols, GSM Abis, and SOCKS, such as V4, V5, and V5.2. Computer networks use protocols, such as: TCP/IP, IPX H.323, AppleTalk, DECNET, OSI, and SNA. As an example of the extent to which a protocol may be used, the SS7 protocol is used for telecommunications, wireless services such as personal communications services (PCS), local number portability (LNP), toll-free and toll wireline services, enhanced call features such as call forwarding, calling party name/number display, and three-way calling.

The use of differing protocols creates complications with the receiving networks. In order for an application to recognize a given protocol, it has to have a dynamic link library specific to the given protocol. A dynamic link library, or DLL, is a module that usually exposes functions that can be linked into an application at run time. In addition to functions, Microsoft® Windows® supports a type of DLL called an extension DLL, which allows a DLL module to expose a class that an application can create an instance of or derive its own class from to add extra functionality.

Network operators/troubleshooters usually depend on a tool to interrogate network messages to remedy problems. Most tools display the captured frames in three ways: (i) a single line of summary information, (ii) a detailed multi-line decode of the entire message, and (iii) a raw dump of the hexadecimal values of the bytes or octets composing the message. Most tools supply a means of filtering-out messages of which a network operator is not interested.

Filtering is used to find messages that contain specified values in particular fields of the protocol. Some tools provide a session filter that determines if a message is part of a group of messages that are associated according to a specific protocol. For example, the telephone signaling network uses signaling messages to control a phone call. The first message when a phone call is placed is an “initial address message,” or IAM, and the last message after the phone is hung up is the “release complete message,” or RLC. A session includes all of the messages from IAM to RLC for a particular phone call.

Applications are required to use different APIs to handle different applications, requiring each program to have its own API. Requiring each program to have its own API is a disadvantage for all the usual reasons, such as duplicity of software, maintainability, upgradability, increased use of memory, etc.

When analyzing network problems, being able to analyze more than one protocol at a time is desirable because more than one protocol may be used in a single session.

### SUMMARY OF THE INVENTION

The present invention relates to protocol analysis and more particularly to a framework of modules controlled by an application program interface that can generically handle differing protocols. A framework of dynamic link libraries (DLL) that exposes a single application programming interface (API) is provided. The API enables an external application to perform protocol analysis (e.g., text decode/filtering) of messages from multiple protocols. The multiple protocols are captured from communication links between network devices. An embodiment of the framework has been designed for Windows® C++ applications, but may be redesigned with minimal effort to work on other operating systems, such as UNIX®, or applications written in other programming languages, such as C or Java™.

One embodiment of the present invention includes analyzing multiple protocols simultaneously. In a modularized framework, new protocol-specific modules can be added when analysis of new protocols is required.

The framework includes a capability of automatically loading and initializing protocol-specific DLL modules on an as-needed basis, thus relieving the API from being required to manage the loading and initializing tasks. If a library for a requested protocol does not exist, the framework maps a default library to do minimal decoding and filtering.

The framework can also include decoding functions, which supply in grid-type manner the text that is displayed at column and row intersections, thereby allowing the external application to expect common screen formatting across different protocols. The framework makes use of a decoded message cache that allows multiple calls for each row and column to do the decode work once, and then simply return stored values after the first call.

The framework can also include an ability to display dialogs for the selection of filtering parameters. The dialogs are specific to each protocol and are handled from inside the framework. The external application performs a test for true or false returned from an API function, which tests if the captured message passes the filter criteria. The external application's usage of the API function greatly simplifies the burden placed on the external application.

Another embodiment of the API includes an ability to accept application-specific formatting requests and processes, supplied from an application level application of the International telecommunications Union (ITU) standard communication hierarchy protocol that affect the decoded output values for selected protocol fields.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of an example network system in which an embodiment of the present invention may be deployed;

FIG. 2 is a block diagram of an embodiment of a protocol analysis framework of the present invention having an application programming interface (API) employed by any of the network devices in the network system of FIG. 1;

FIG. 3 is a top level block diagram of the decode management API, protocol-specific DLL, and base protocol DLL provided in the protocol analysis framework of FIG. 2;

FIG. 4 is a flow diagram of the decode management API of FIG. 2 in response to an API call from an external module;

FIG. 5 is a flow diagram of an embodiment of an API routing process executed by a decode management API shown in the protocol analysis framework of FIG. 2;

FIG. 6 is a list of typical API calls for using the decode management API of FIG. 3 to decode captured network messages; and

FIGS. 7A-7B are tabular data displays provided as an output by the decode management API of FIG.3; and

FIG. 8 is a list of software calls to the decode management API of FIG.3.

### DETAILED DESCRIPTION OF THE INVENTION

A description of preferred embodiments of the invention follows.

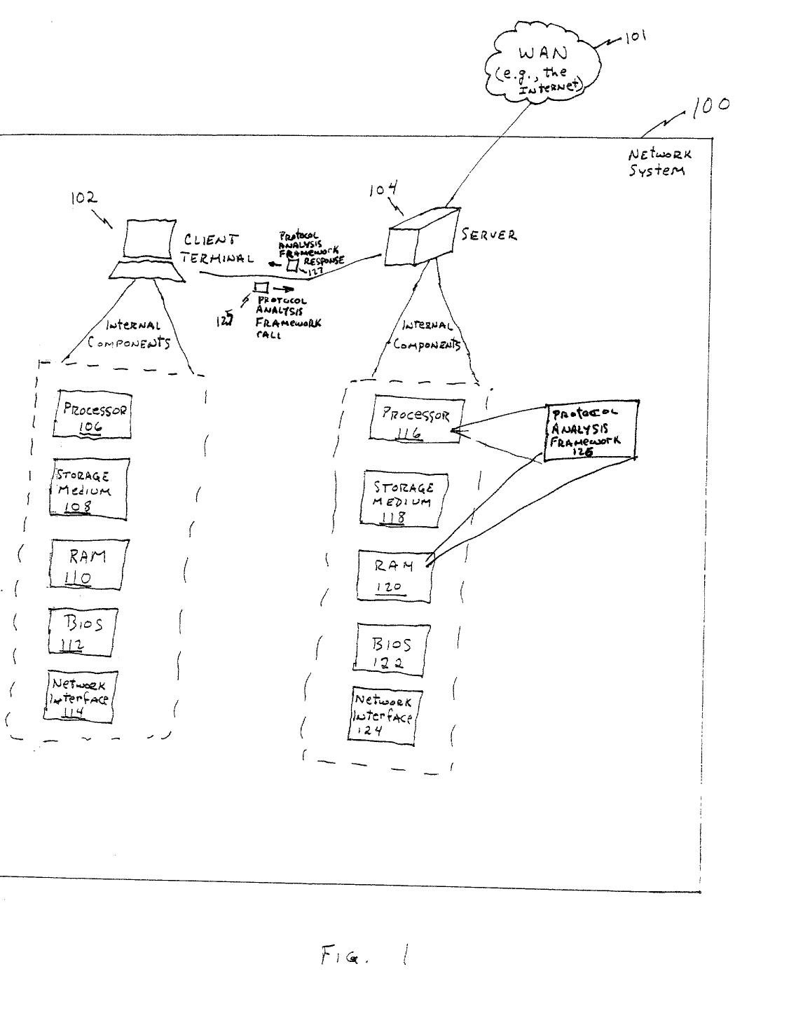

FIG. 1 is a block diagram of a network system 100 having a client terminal 102 and server 104, in which the present invention may be utilized. The network system 100 may include additional client terminals 102 and additional servers 104, in which the present invention may also be utilized. The server 104 provides access to a local area network (LAN) or wide area network (WAN) 101, such as the Internet.

The client terminal 102 includes processor 106, storage medium 108, RAM 110, BIOS 112 and network interface 114. The processor 106 executes control software and application software. Control software includes an operating system, system drivers, and system utilities. Application software may be a local application or any application that is suited for network operation, such as a communications application or a retail application.

The storage medium 108 may be a hard disk or floppy disk. The RAM 110 stores code and data segments during execution by the processor 106. The BIOS 112 provides low-level instructions, which allow the processor 106 to initiate loading and executing software. The BIOS 112 is preferably storage, such as ROM. The Network interface 114 includes standard hardware and software for establishing communications with the server 104.

The server 104 includes components similar to the terminal 102, such as a processor 116, storage medium 118, RAM 120, BIOS 122 and network interface 124.

A network operator may use the client terminal 102 to observe network communications being transacted on the server 104 and another server, for example, on the WAN 101. Through the use of a protocol analysis framework 126 stored in the RAM 120 and loaded and executed by the processor 116, the operator is able to view data of various protocols, including application specific protocols, optionally in tabular form.

The operator uses the client terminal 102 to execute a protocol analysis framework call 125 and, in turn, receives a protocol analysis framework response 127. The response 127 includes decoded data of one or more protocols and may include additional formatting data for tabular display of the decoded data. It should be understood that the generation of the protocol analysis framework call 125 may be generated in (i) an automated manner in response to a predetermined criteria, such as network error detection or initialization decoding (i.e., Integrated Services Digital Network (ISDN) format), or a manual manner, such as for network investigation purposes.

The protocol analysis framework 126 has a common interface for detecting and selecting dynamic link libraries (DLL) that are needed to analyze data of various protocols that are used in data communications between the server 104 and other electronic devices (not shown) on the WAN 101. The common interface means that external programs using the framework need not duplicate software, and the common interface can more easily be maintained, upgraded, have minimized memory usage, etc.

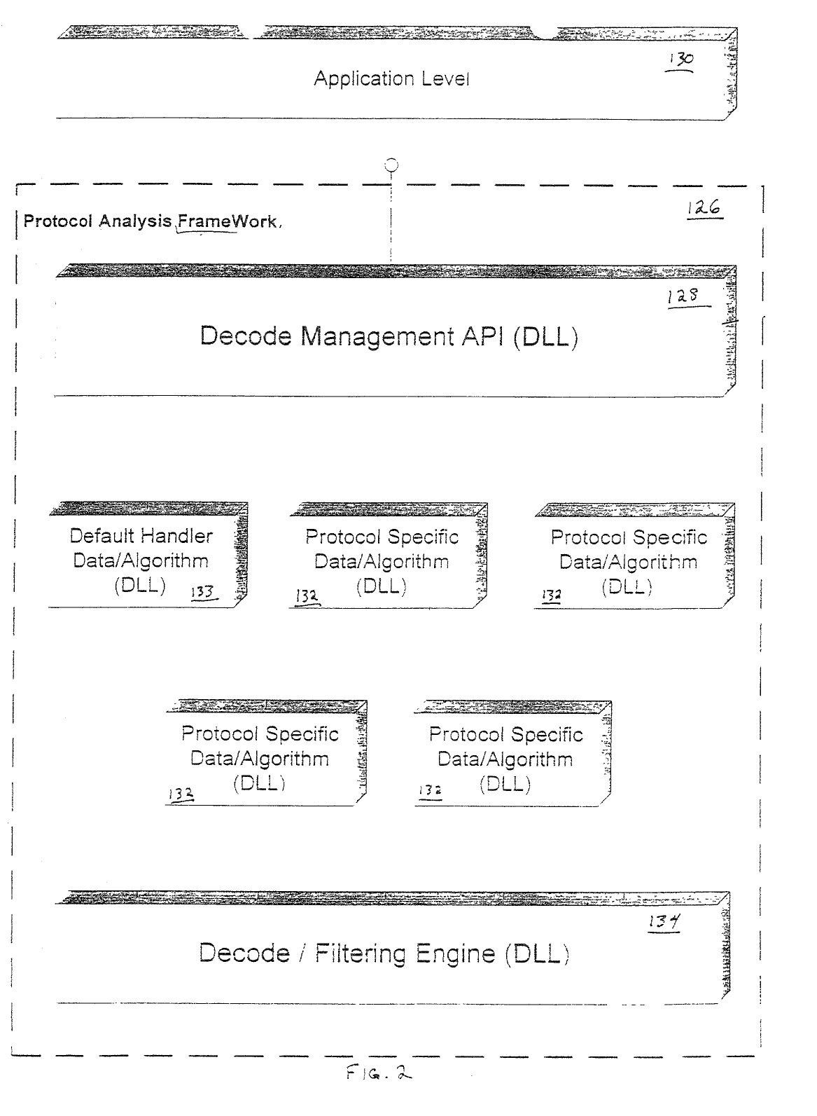

FIG. 2 is an overview block diagram of an embodiment the architecture of the present invention. A protocol analysis framework 126 is managed by a decode management application programming interface (API) 128, which may be a Dynamic Link Library (DLL)—statically linked and dynamically loaded. Functions that compose the decode manager API 128 are typically stored in a DLL, and loaded into run-time memory of the server 104 (FIG. 1) when the decode manager API 128 is used.

The protocol analysis framework 126 is executed by a network device 102, 104 of FIG. 1. Another device that can employ the protocol analysis framework 126 is a message server, such as a message director used as a gateway between a mainframe computer and a modern computer network, which is discussed in U.S. patent application Ser. No. 09/872,756, entitled “Message Queue Server System,” filed Jun. 1, 2001. Further, the protocol analysis framework can be employed by a 7View™ product by INRANGE® Technologies Corporation for decoding and filtering signaling messages from an SS7 network.

The protocol analysis framework 126 has at least one protocol specific DLL 132 and at least one default data handler DLL 133. The decode manager API 128, protocol specific DLLs 132, and default data handler DLL(s) 133 may interface with a decode/filtering engine DLL 134.

The decode manager API 128 interfaces with an application 130 on the application level of the ITU standard network protocol (e.g., SS7). Applications found on the application level may include call analysis, link analysis, or a message analysis. Any such application may call the decode manager API 128 to investigate protocol data any time a message that had been recorded from a network needs to be converted into readable text. Applications employing the decode management API 128 could be any application that can view, use, or discern network packet frame data for any reason (e.g., network browser or word processor).

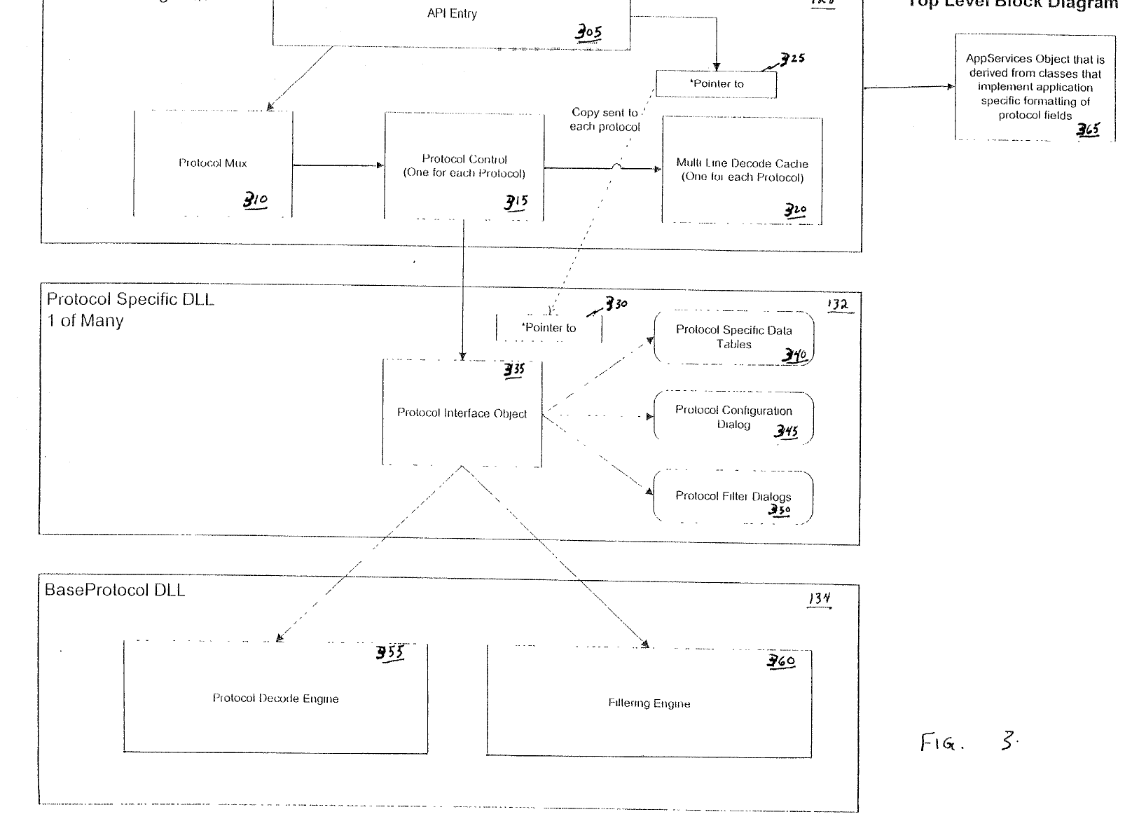

FIG. 3 is a block diagram of the decode manager API 128, the protocol specific DLL 132, and the base protocol 134. The block diagram shows the major blocks of functionality in each level of the framework and the interaction of blocks at the various levels with blocks at other levels.

The decode manager API 128 includes an API entry function 305 that is called from an external application (not shown). The decode manager API 128 also contains a protocol multiplexer (MUX) 310, which communicates with a protocol control object 315 for each protocol-specific DLL that is loaded. Each protocol control object 315 communicates with a multi-line decode cache 320 and a pointer 325. The pointer 325 points to a protocol interface object 335 in the protocol specific DLL 132 that the protocol control object 315 is controlling. A pointer 325 to an application services object 365 is also stored in the decode manager API 128 and, if initialized via an API function, is given to each protocol-specific DLL 132 in a loaded state.

Each protocol specific DLL 132 exposes a protocol interface object 335 belonging to a given protocol interface class that loads the base protocol DLL 134, which supplies the protocol decoding and filtering functionality. The protocol decoding and filtering functionality is provided by a protocol decode engine 355 and protocol filtering engine 360, respectively.

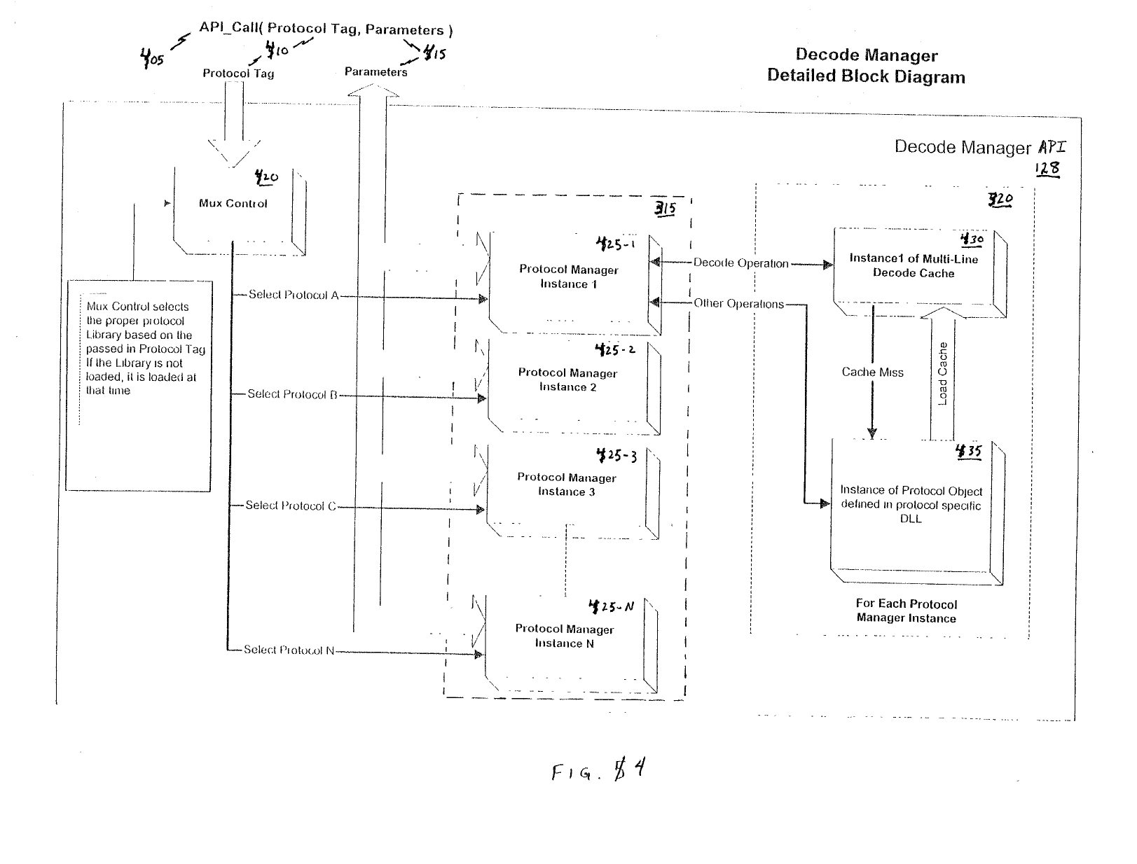

FIG. 4 is a detailed functional block diagram of the decode manager API 128. A multiplexed (mux) control object 420 uses a protocol tag 410 passed in an API function call 405 to route the function call 405 to the appropriate protocol specific API function 132. If the value of the requested tag 410 cannot be found, the mux control object 420 automatically loads a protocol specific DLL 132 and creates a respective protocol manager instance 425 for the tag 410. If the protocol-specific DLL 132 is not on the disk for the tag value requested, a generic protocol DLL 133 is loaded for that tag value. If the protocol manager API 128 detects that the function call 405 is not a decode function, it forwards the function call 405 directly to the protocol-specific DLL function 132. If the function call 405 is a decode function, the protocol manager instance (e.g., 425-1) protocol manager API 128 looks in the respective decode cache 420 for an entry matching the message to be decoded. If there is no entry in the decode cache 430 or protocol object 435 for the message that is to be decoded, the respective protocol-specific DLL decode function 132 is called.

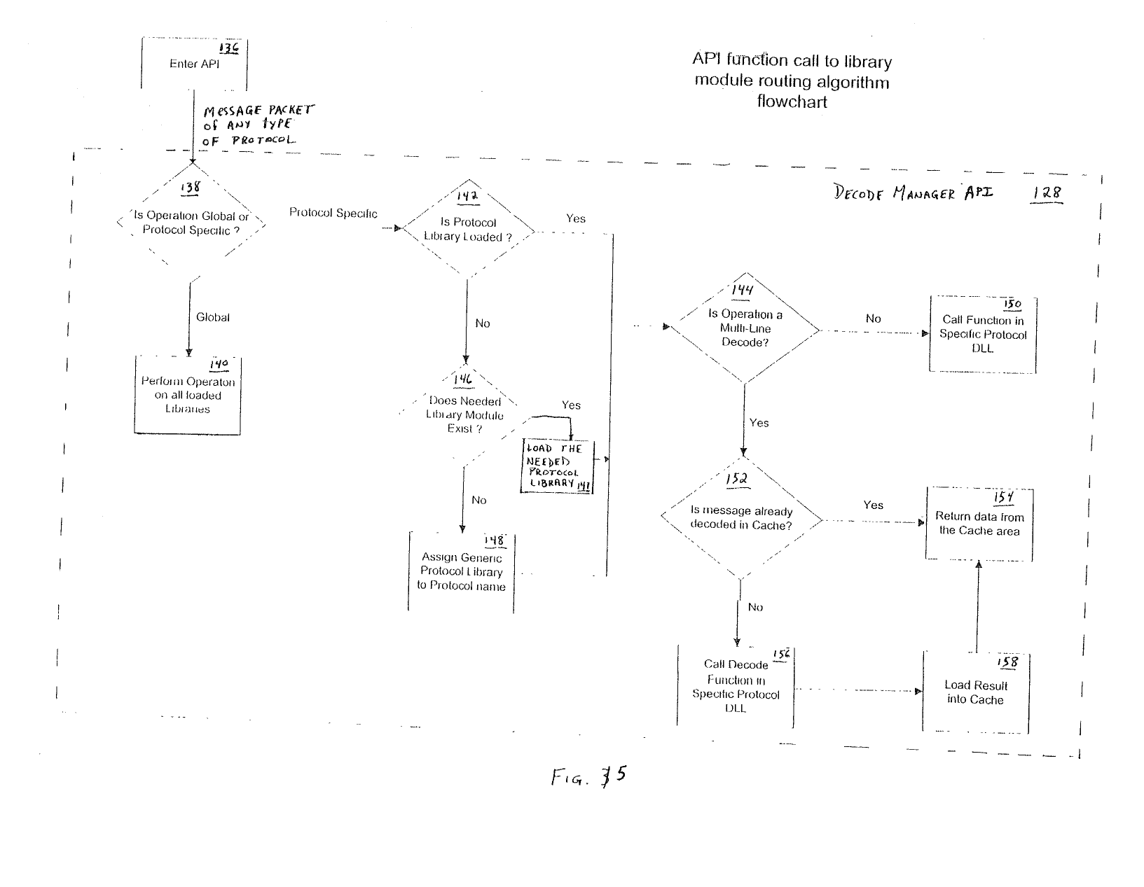

FIG. 5 is a flow diagram of the API routing process performing protocol analysis, which is stored in the library routing module, executed by the decode manager API 128. The protocol analysis begins in step 136, where a message packet of any type of protocol enters the decode manager API 128. Message capture is typically not part of the decode manager API 128; message capture is up to the application that uses the decode manager API 128 to retrieve data. Message capture is done by a live sampling of a network wire(s) or previously captured data that is stored in a database and retrieved later.

In step 138, the decode manager API 128 determines whether the operation request by the message packet is global or protocol-specific. If the message packet is global, in step 140, the decode manager API 128 performs the operation on all loaded libraries. If the message packet is protocol-specific, then, in step 142, the decode manager API 128 inquires whether the protocol library has been loaded. If the protocol library has already been loaded, the decode manager API 128 continues to step 144 to look at which type of decode—single or multi-line decode—is to be done.

If the protocol library has not been coded, then, in step 146, the decode manager API 128 determines whether the required library module exists. If the needed library module exists, then the decode manager API 128 proceeds to step 147 to load the needed protocol library, which is followed by step 144. If the needed library module does not exist, then in step 148, the decode manager API 128 assigns the generic protocol library 133 (FIG. 2) and the decode/filtering engine DLL 134 to the protocol name. Following that assignment, the process proceeds to step 144.

If the decode manager API 128 determines in step 144 that the processing of the operation contained in the message packet includes a single-line decode, then, in step 150, the decode manager API 128 calls a function in the protocol specific dynamic link library. If the operation requires a multi-line decode, then the decode manager API 128 continues in step 152 to determine whether the message is already decoded in cache. In other words, a multi-line decode operation first looks in the cache before actually calling a corresponding protocol specific DLL 132, and non-multi-line decode operations call directly through to a corresponding protocol-specific DLL 132.

If the message is already decoded in cache, then the decode manager API 128 returns data from the cache in step 154. If the message is not yet in cache, then, in step 156, the decode manager API 128 makes a call to a decode function having a specific protocol. The results are loaded into cache in step 158, and then data are returned from the cache in step 154.

The protocol-specific DLLs and decode manager API 128 have similar functions except the decode manager API 128 has an extra parameter that specifies the function on which the protocol is to be invoked.

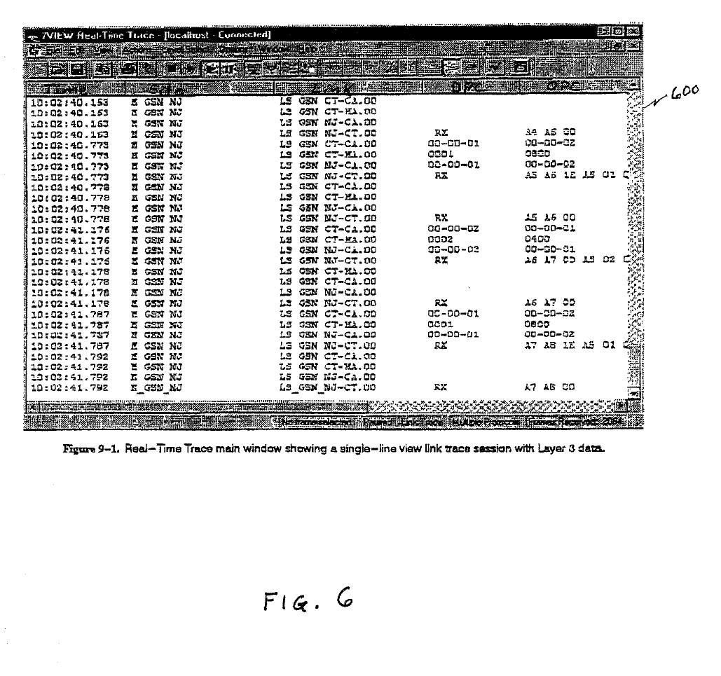

FIG. 6 is a main window 600 of a real-time call trace application that employs the protocol analysis framework 126 to decode, filter, and/or analyze protocol data from an SS7 network. An example of such an application is discussed in U.S. Provisional Application No. 60/254,839 entitled “Real Time Call Trace Capable of Use With Multiple Elements,” filed Dec. 12, 2000, by B. Hannigan. That application discusses how an operator, investigating why a phone call is problematic through a telephony system having an SS7 network, can use a call trace system to assist in performing the investigation. The call trace system is connected to the SS7 network, which supports real-time call tracing. The call trace system captures SS7 protocol data whose processed and/or filtered form is to be interpreted by the operator. Examples of data captured by the call trace system include originating point code (OPC) and destination point code (DPC) addresses.

The real-time call trace system just described can use the protocol analysis framework 126 to perform, display, filter, and decode the captured SS7 protocol data. In this way, the real-time call trace system need not have its own analysis tools, thereby saving memory resources, processing resources, and software development redundancy. In other words, protocol data captured by the real-time call trace system can simply provide parameters to the protocol analysis framework 126 including the captured protocol data and receive from the protocol analysis framework 126 decoded and filtered data that may include display information, such as how to display the decoded and filtered data in a tabular format.

Continuing to refer to FIG. 6, the main window 600 includes five columns, labeled: time, site, link, DPC, and OPC. The decoded protocol data is listed in their respective columns.

The decode manager API 128 in the protocol analysis framework 126 of FIG. 2 can inform an application, such as the real-time call trace system in the SS7 network described above, of the number of columns for a particular protocol name. The application can then ask the decode manager API 128 for the name of each of the columns once it knows how many columns it has. An application can get the text that belongs in each of the columns by providing the raw data captured along with the name of the column for a particular protocol name. The main window 600 of FIG. 6 is an example of the columns generated by the real-time call trace system described above.

The real-time call trace main window 600 shows a single-line view link trace session with Layer 3 data. The computer on which the main window 600 is displayed is assumed to provide a human-to-machine interface, such a computer mouse, which an operator can use to select any of the single-line protocol data in the main window 600 that has been decoded by the protocol analysis framework 126.

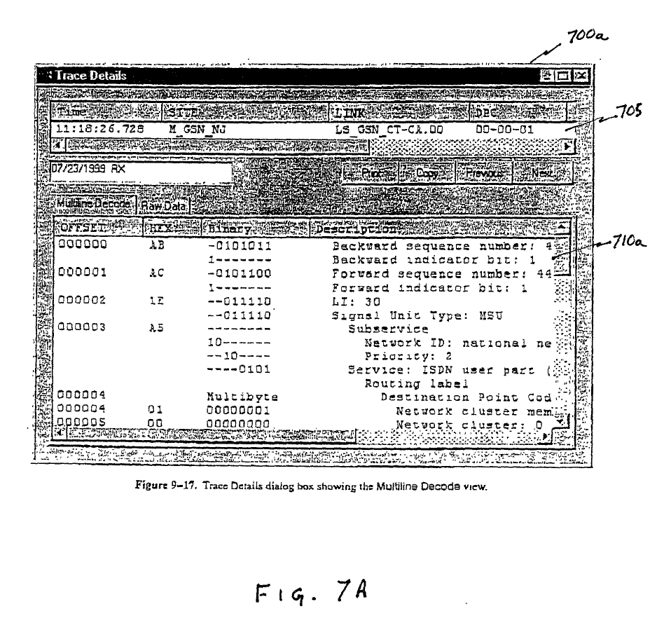

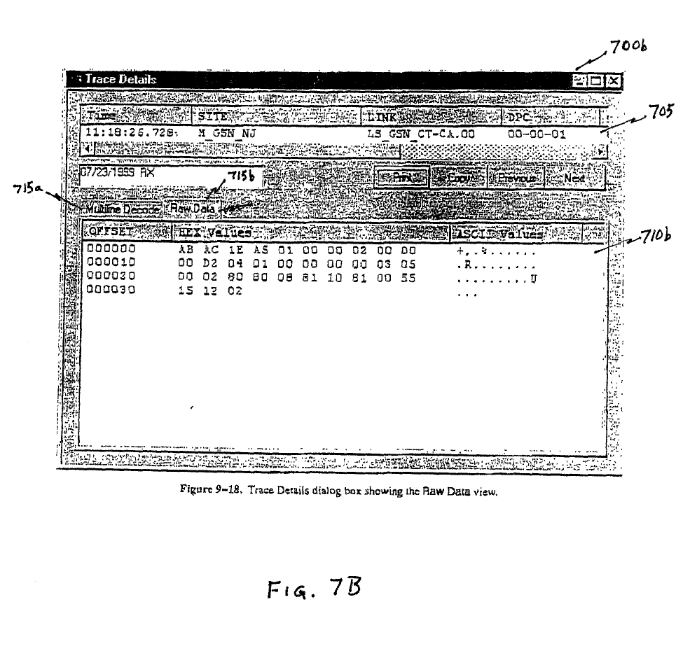

FIG. 7A and 7B are dialog boxes 700a and 700b, respectively, showing trace details of the selected single-line protocol data from the main window 600. In FIG. 7A the dialog box 700a includes a single-line decode text box 705 and multi-line decode text box 710a. The single-line text box 705 displays a concise summary of the frame/message data based on the level of detail specified via a “Level Select” pull-down menu choice and may be filtered or unfiltered depending on the setup specified by the operator. The multi-line decode text box 710a displays a respective, completely decoded frame corresponding to the single-line data in the single-line decode text box 705.

FIG. 7B displays the same information in dialog box 700b as was displayed in the previous dialog box 700a. However, in the multi-line text box 710b, the raw data corresponding to the protocol data in the single-line text box 705 is displayed. The selection of the decoded data or raw data in the multi-line decode text box 710b is determined as a function of an operator selection of a “multi-line decode” tab 715a or “raw data” tab 715b.

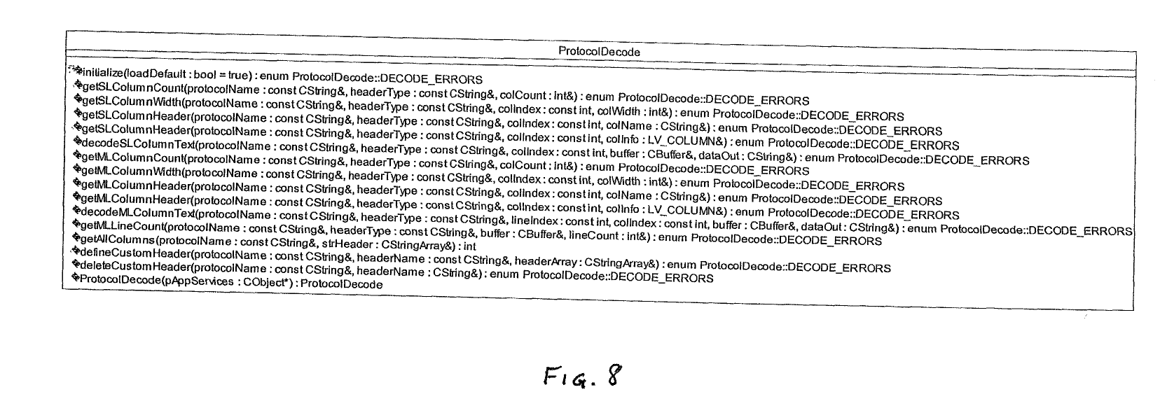

The real-time call trace application described in references to FIGS. 6 and 7A-B uses the protocol analysis framework described in reference to FIGS. 1-5 to provide the processing for the single-line text box 705 and the multi-line text boxes 710a, 710b. To understand the relationship between an external application and the protocol analysis framework 126, an exemplary set of calls made by the decode manager API 128 to the protocol specific DLLs 132 (FIG.2) for decoding captured network messages are provided in FIG. 8.

Referring to FIG. 8, the function calls with “SL” in the function call name are for a single line decode format for the single-line test box 705 (FIG. 7A), and the functions with “ML” in the name of the function call are for multi-line decode format for the multi-line text box 710a (FIG.7A). The single-line format is a summary of Layer 2 or Layer 3 data depending on the header Type passed in. Custom SL headers can be defined and deleted with the use of Custom header functions, listed near the bottom of the list of calls made by the decode manager API 128.

The multi-line format decodes the fields in a message or creates an ASCII representation of the hexadecimal bytes that make up the message depending on the header Type passed in. Caching of decoded text is important, because once the column and line count is determined, decode functions must be called repeatedly for each column and line in the case of ML decoding.

The protocol tag 410 (FIG. 4) represents the protocolName field in the calls made by the decode manager API 128. All the other parameters are passed to the protocols specific decode DLLs 132 (FIG. 2).

It should be understood that software used to implement the teachings of the present invention are shown in FIG. 8 as object-oriented C++ code, but can be any form of software, including non-object oriented software. Further, the software may be stored in a computer readable medium (e.g., CD-ROM, magnetic disk, or other form of digital memory) and loaded and executed in a single processor or distributed among plural processors, including on processors connected via network link(s).

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for performing multiple protocol analysis, comprising:
at least one protocol-specific dynamic link library to analyze at least one protocol;
a default dynamic link library to analyze a different protocol that does not correspond to said at least one protocol-specific dynamic link library; and
an application program interface (API) managing said at least one protocol-specific dynamic link library and said default dynamic link library to perform multiple protocol analyses.

2. The system according to claim, wherein analyzing said at least one protocol includes decoding and filtering.

3. The system according to claim 1, wherein said at least one protocols are used for data transport.

4. The system according to claim 1, wherein said application program interface is a dynamic link library.

5. The system according to claim 1, further including means for enabling an addition of another protocol-specific dynamic link library to analyze an additional protocol.

6. The system according to claim 1, wherein an application external from the system and in communication with the system uses said protocol-specific dynamic link library to read a specific protocol, without the application managing or reading the protocol.

7. The system according to claim 1, wherein the system includes a module applying common screen formatting across different protocols to display results of at least one analysis.

8. A system according to claim 7, wherein the results are displayed in a grid having rows and columns.

9. A system according to claim 8, further including a decoded message cache to store the results in the grid for later retrieval.

10. The system according to claim 9, wherein said decoded message cache receives multiple requests for a subset of results in the grid.

11. The system according to claim 1, further comprising at least one dialog display coupled to said application program interface to receive a selection of filtering parameters from a user.

12. The system according to claim 11, wherein said at least one dialog display corresponds to a respective protocol.

13. The system according to claim 1, wherein the application program interface accepts application-specific formatting processes supplied from an external application, wherein the processes affect decoded output values for selected protocol fields resulting from the protocol analysis by a respective library.

14. A method for performing multiple protocol analysis, comprising:
providing at least one protocol-specific link library;
providing a default dynamic link library;
using one of the dynamic link libraries, analyzing at least one protocol to decode and filter said at least one protocol; and
managing said at least one protocol-specific dynamic link library and said default dynamic link library to perform multiple protocol analyses.

15. The method according to claim 14, wherein analyzing said at least one protocol includes decoding and filtering.

16. The method according to claim 14, wherein said at least one protocol is used for data transport.

17. The method according to claim 14, wherein managing said at least one dynamic link library includes employing an application program interface (API).

18. The method according to claim 14, further including enabling another protocol-specific dynamic link library for analyzing an additional protocol.

19. The method according to claim 14, further including enabling a protocol-specific dynamic link library to be used by an external system for reading a specific protocol.

20. The method according to claim 14, further including applying formatting across different protocols to display results of at least one analysis.

21. The method according to claim 20, further including displaying the results in a grid having rows and columns.

22. The method according to claim 21, further including storing the results in the grid in a decoded message cash for later retrieval.

23. The method according to claim 22, further including receiving multiple requests for a subset of results in the grid.

24. The method according to claim 14, further including receiving a selection of filtering parameters from a user.

25. The method according to claim 24, wherein the filtering parameters correspond to a respective protocol.

26. The method according to claim 14, further including accepting application-specific formatting processes supplied from an external application, wherein the processes affect decoded output values for selected protocol fields resulting from the protocol analysis by a respective library.

27. An apparatus for performing multiple protocol analysis, comprising:
means for determining whether a protocol is a default protocol or a specific protocol;
based on the results of the determination, means for analyzing the protocol by using a default dynamic link library or a protocol-specific dynamic link library; and
means for managing said at least one protocol-specific dynamic link library and said default dynamic link library to perform multiple protocol analyses.

28. An apparatus for performing multiple protocol analysis, comprising:
an application program interface to receive a message having network data of a default protocol or a specific protocol and to return a processed representation of the network data;
a default dynamic link library in communication with and managed by the application program interface to receive the network data from the application program interface if the network data is of the default protocol and to process the network data for the application program interface; and
at least one protocol-specific dynamic link library also in communication with the application program interface to receive the network data from the application program interface if the network data is of the specific protocol and to process the network data for the application program interface.

29. A computer-readable medium having stored thereon sequences of instructions, the sequences of instructions including instructions, when executed by a digital processor, causes the processor to perform:
providing at least one protocol-specific link library;
providing a default dynamic link library;
using one of the dynamic link libraries, analyzing at least one protocol to decode and filter said at least one protocol; and
managing said at least one protocol-specific dynamic link library and said default dynamic link library to perform multiple protocol analyses.

30. A method for performing multiple protocol analysis, comprising:
receiving a protocol decode request having captured network data from an external application;
determining whether the network data requires a given protocol specific library function to decode the network data;
if the given protocol specific library function is not available, loading the given protocol specific library function to decode the network data; and
transmitting a decoded representation of the network data to the external application.
